(19) United States
(12) Patent Application Publication
(10) Pub. No.: US 2004/0017899 A1
(43) Pub. Date: Jan. 29, 2004

(54) Caller ID generation

(76) Inventors: Dean R. Garfinkel, Old Brookville, NY (US); Alison K. Garfinkel, Old Brookville, NY (US)

Correspondence Address: BAZERMAN & DRANGEL, P.C., 60 EAST 42ND STREET, SUITE 820, NEW YORK, NY, 10165, US

(21) Appl. No.: 10/630,469

(22) Filed: Jul. 29, 2003

Related U.S. Application Data
(60) Provisional application No. 60/399,237, filed on Jul. 29, 2002.

(51) Int. Cl. H04M 1/64; H04M 1/56; H04M 15/06

(52) U.S. Cl. 379/88.21; 379/142.04; 379/142.06

(57) ABSTRACT

The present invention is a method for providing caller ID information for outgoing telephone calls from a company which is required to provide caller ID information to the number called. The system reviews each outgoing call at a switch cluster of a carrier to determine if the call requires caller ID information. Should the call require caller ID information, the system will determine if the outgoing telephone call is carrying the originating call's caller ID information or a valid caller ID information packet. If the call is not carrying any caller ID information or an invalid caller ID information packet, the system of the present invention will provide a predetermined caller ID information packet to the switch cluster to be matched with the call. In instances where caller ID information is not required, the system will allow the call to continue without analyzing the caller ID information.

### PRIORITY

This application claims priority of pending U.S. Provisional Application No. 60/399,237.

### BACKGROUND OF THE INVENTION

1 Field of the Invention

The invention concerns communication systems generally and more specifically, concerns the insertion of caller ID information for telemarketers for assuring compliance with Federal and State Caller ID transmission rules.

2. Prior Art

In recent years the door-to-door salesman has been replaced by telephone solicitation. Rather than a salesman walking a route, a telemarketer makes a series of telephone calls. The telephone numbers dialed are normally on a call list given to the telemarketing salesman by his employer. The call list may be organized by address, consumer information or by the numbers themselves. Just as the consumer can slam the door in the face of a door-to-door salesman, the consumer may hang up upon receiving a telephone solicitation. However, the call itself is considered by many to be an intrusive act. Telephone solicitation nonetheless is an extremely cost-efficient marketing channel. However, the very success of telephone solicitation has produced a backlash of sorts—many consumers are desirous of being protected from even receiving such calls.

To date, twenty-five (25) states have created so-called “Do Not Call” registries for consumers seeking to reduce unwanted telephone solicitations. The Federal Government has also recently created a “national” Do Not Call list. Telemarketers are required to adopt policies and procedures which ensure that the numbers on these Do Not Call registries are not called. In addition, telemarketers must maintain a list of persons who specifically request that company not to call again (“company” Do Not Call lists.) Fines can be assessed against companies that call numbers on any State, Federal or Company Do Not Call list.

Various systems have been developed to aid individual telemarketers' in meeting these “do-not-call” requirements under federal and state law. U.S. Pat. No. 6,330,317(“317 Patent”), issued to Dean Garfinkel on Dec. 11, 2001, discloses a system which automates at a central location meeting the “do-not-call” requirements of multiple telemarketers by blocking the actual calls.

As a further protection to the consumer, The Federal Trade Commission requires that all telemarketing calls be identifiable, i.e., caller information for each telemarketing call should be available to the recipient by means of the recipient's caller ID service. The regulations require that the identification include a telephone number manned by a live operator. However, older central switching equipment and switching equipment which either has not been upgraded to the latest software or is awaiting development of the necessary software, is unable to transmit caller information. Equally the telephone number of the calling telemarketer is not always the appropriate number to receive a manned response to quires and complaints. As a result the FTC requirements may not be met by a number of telemarketers.

While systems exist to substitute caller IDs for individual telephone numbers and trunk lines, there has not been until the present invention, a system to automatically ascertain whether any individual call in a multi telemarketer environment has caller ID information and if not to supply such information for the specific telemarketer placing the call or if there is a caller ID information to substitute caller ID information for that telemarketer to allow redirection of return calls. More specifically, U.S. Pat. No. 5,901,209 discloses a predictive dialer system providing caller ID substitution for telephone callers from a single telemarketer which enables a caller to utilize the Internet to select a caller ID substitution. U.S. Pat. No. 6,343,120 discloses a method and apparatus for providing alternative caller ID alias (i.e., company name or the like) by a database at the terminating switch. U.S. Pat. No. 5,283,824 discloses a method and apparatus for enabling a calling party to specify at the initiation of the call the number appearing as the calling party's caller identification number. U.S. Pat. No. 5,590,184 discloses a communications privacy protection system which enables a calling party on a call by call basis to selectively replace the calling party's caller identification number with a randomly generated non-assigned number. U.S. Pat. No. 6,278,774 discloses a communication apparatus connected to a communication network, wherein the apparatus enables a user to select a desired caller identification on a individual call basis. None of these discloses either add caller ID information to calls on switches which do not normally have this function nor do they teach how to automatically supply Caller ID information in a multi telemarketing environment.

### SUMMARY OF THE INVENTION

The invention, while separate and distinct from U.S. Pat. No. 6,330,317, (“'317”) which may be used as a stand alone is best used in conjunction with '317 system. In the '317 system, a call is routed through a system which matches the originating and destination phone numbers. The system then determines if the call should be allowed and completed (see U.S. Pat. No. '317). Should the call be allowable, the call is passed through by the telephone carrier for completion. Originating calls contain a set of information which is carried with the call. This information commonly includes Caller information which is used by the caller ID system. In some instances, particularly with older switching systems, the Caller information does not originate and therefore is not carried with the call. If the Caller information is not carried with the call, the receiver of the call is unable to view the originating caller information on his/her caller ID display system.

There are currently a number of bills at the Federal and State level which require that all calls be identifiable. This invention solves this problem. After the call is placed and is authorized for completion, a new step is introduced to the existing '317 system or as a stand alone system. The call is analyzed to determine if Caller information is present. If the Caller information is not present, the system will retrieve a Caller information from the insert Caller information database. The Caller information is chosen from the database based on the originating trunk identification. The call will then continue as described in the '317 system. It will be routed to its final destination where the receiver of the call can view the originating caller information on his/her caller ID display system.

### BRIEF DESCRIPTION OF THE DRAWINGS

The invention can be more fully understood from consideration of the following detailed description of an illustrative embodiment of the invention and the accompanying drawings in which:

FIG. 1 is a diagrammatic representation of the components of the control system;

FIG. 2 is a flow diagram showing the Caller ID generation process in conjunction with a call blocking program;

FIG. 3 is a flow diagram of showing the Caller ID generation process as a stand alone system.

### DETAILED DESCRIPTION OF THE PREFERRED EMBODIMENT

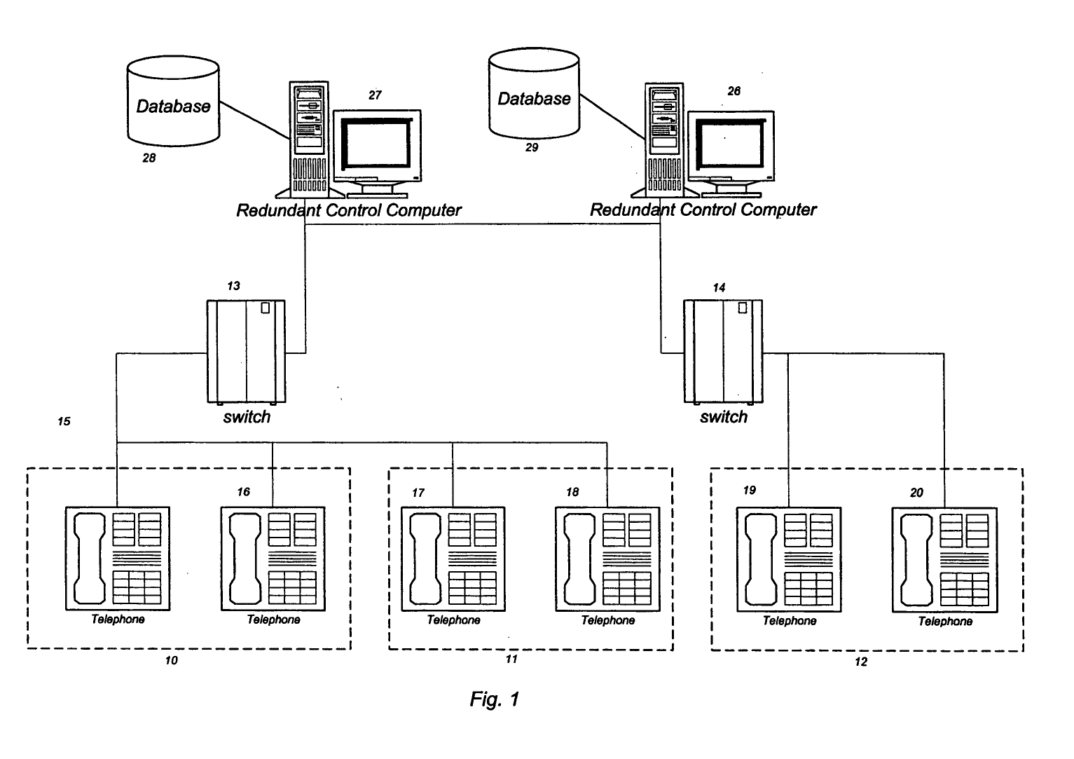

FIG. 1 is a diagrammatic representation of how the control computer of the present invention interconnects with the normal communication system. Telemarketing customer companies 10-12 receive their telephone services from one or more telephone companies or carriers. The customer companies 10-12 are connected to its own telecommunications company provider by conventional means such as plain old telephone service lines (POTS), T1 line, feature D, or any other conventional telephonic linkage. The telecommunication company provides a dial tone to the customer for a telephone call and performs all normal communication functions. Calls are placed from hand sets 15-20 at the respective customers 10-12 to their local primary telephone switch cluster 13-14.

As seen in FIG. 1, customer companies 10 and 11 have their telephone service provided through the same primary switch cluster 13. Customer company 12, has its telephone service provided through primary switch cluster 14. As is normal with any telephone call, when a call is placed from handsets 15-20 information both as to the originating number of the hand set and the destination number which was dialed by the customer company (i.e., the originating/destination pair) is supplied at the switch cluster 13-14. In normal operation, the primary switch cluster 13 and 14 would determine the carrier which controls the destination number and then route the call to the destination number's switch. In the present system, the switch cluster 13-14 determines from the originating number whether the call is to be reviewed for a determination of whether the call should continue based on a do not call list. If the originating number is that of a telemarketer using the service, the switch holds the call and determines if the call should proceed based on a comparison to the do-no-call list stored in a control computer. Should the call be allowed to proceed, the call is analyzed for Caller ID information. If the call is not carrying the originating number's Caller ID information, the switch cluster 13-14 holds the call and a control computer 26-27 inserts the Caller ID information desired by the telemarketer as referenced by their respective Caller Information Database either stored on that computer 26-27 or in separate storage means 28-29. While the preferred order is to have the system check the “do-not-call” list before analyzing the Caller ID information, the process may be reversed and the system may perform the Caller ID analysis and insertion before checking the originating/destination pair against a “do-not-call” list.

In actuality, there may be two or more redundant control computers 26-27 performing the function. While each such computer will be designed to handle the complete load of anticipated call traffic, the traffic load may be divided evenly between the redundant computers 26-27. Thus, if one of the control computers 26 cannot handle a call routed to it for any reason, one of the alternative control computers 27 can automatically take over. Although shown as two computers in FIG. 1, a number of such redundant computers may be used and, in fact, such control computers may be geographically distributed throughout the country, creating a system with multiplex redundancies and, therefore, extremely high reliability. Geographic distribution also makes this system more easily adapted to handle numerous wide-spread offices of a telephone company in a uniform manner. Of course, the database 28-29 for each of the redundant computers would have duplicate information and their updating be improved so that each control computer 26-27 would respond in the same way in making a call blocking decision.

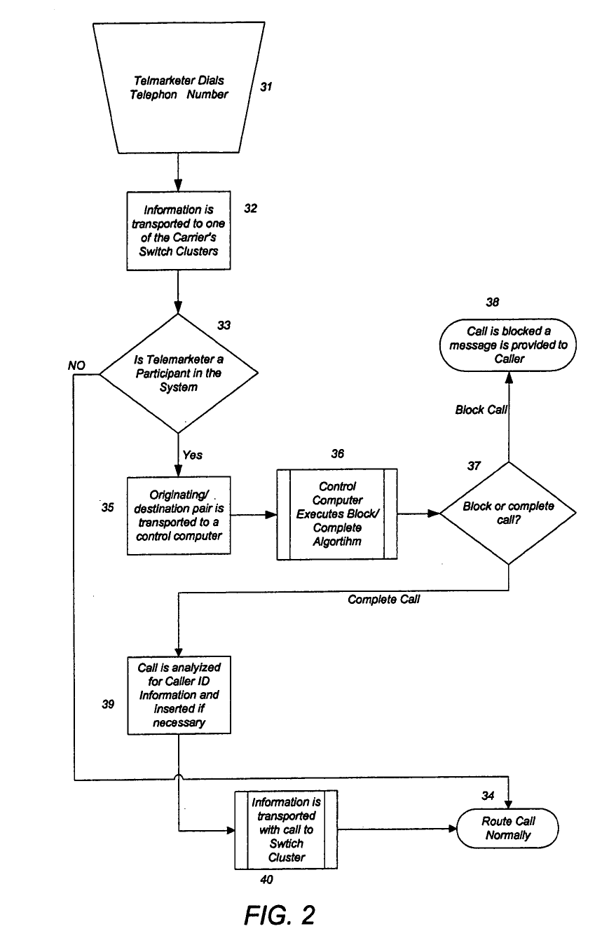

FIG. 2 is a flow diagram showing the Caller ID generation in conjunction with a call blocking program. The telemarketer of a customer company 10-12 dials his handset 15-20 in a conventional manner 31. As normal in modern telecommunications, by so dialing the handset 15-20, the customer company 10-12 originates a signal corresponding both to the dialer's originating telephone number or where the handset is on a trunk line, its identification, and the destination number, i.e. the originating/destination pair. This information is transported in the normal manner 32 to the telemarketer's telecommunication company's carrier's primary switch cluster 13-14.

At the cluster, the switch 13-14, the call is analyzed to determine if the call originates from a handset 15-20 which is from a customer company 10-12 which subscribes to a call blocking system. If the originating handset is not from a subscribing company, the call is automatically routed normally 34 to the switch which controls the destination telephone number. However, when the call originates from a telephone handset 15-16 which is a subscriber of a call blocking system the call is held at the switch cluster 13-14 and the originating/destination pair information is transported 35 to one of the control computers 26-27. The control computer 26-27 then determines first if the call should continue based on the “do-not-call” list stored in the control computer. In some instances, the destination number may be listed on a “do-not-call” list but the call may be completed for certain specific companies. If the originating/destination pair is on an allow/override list, the call is continued. If the call will continue, the call is analyzed for the appropriate Caller ID information 36. The control computer 26 and 27 will analyze 39 the Caller ID Information and if either the caller ID information is missing or the caller requires the generation of a substitute Caller ID with the number of a customer representative, the system will retrieve the Caller ID information 150 and match it with the call 160. In some instances, there will be a zero value or invalid number in the Caller ID information packet and the control computer 26 and 27 will insert 160 the appropriate Caller ID information based on the originating number. Once the Caller ID information is inserted 160, the call is allowed to proceed and is transferred to the destination number's control switch 40. If the present invention is used in conjunction with the blocking system of U.S. Pat. No. 6,330,317, the control computer 26 and 27 can both generate the Caller ID information and perform the blocking function. In either case the entire Caller ID generation and decision making process is very rapid. It is unlikely that a telemarketer will notice any delay in placing the call.

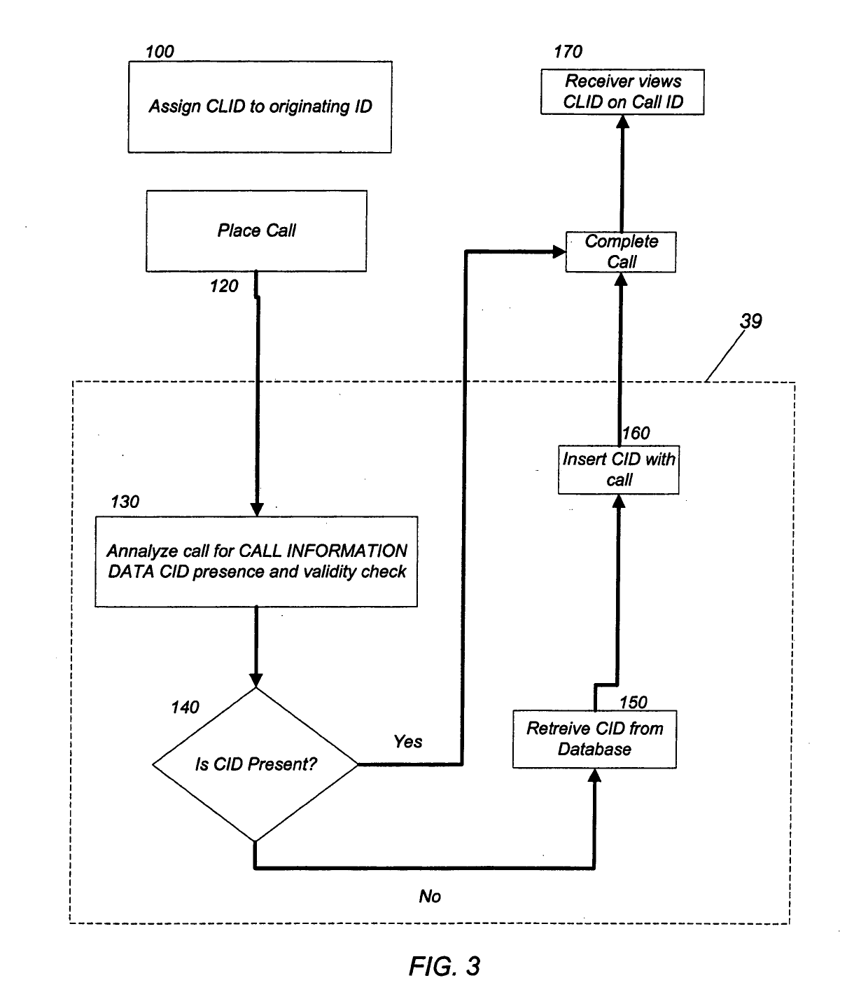

The process of the new invention may be better understood without reference to a call blocking program. As seen in FIG. 3, before placing the original phone call, the calling company must designate 110 which Caller information it wishes the system to assign to the trunk from which calls will be placed. When the originating call is placed 120, the information packet for the call is reviewed 130 to determine if the Caller information is present 140. If the Caller information is not present, the system retrieves the pre-assigned Caller information from the Caller information database 150. Once the inserted Caller information is attached to the originating call, the call is then carried through and completed 160. The receiver of the call may then view the inserted Caller information when the phone rings at the receivers location 70.

It is understood that the present embodiments described above are to be considered as illustrative and not restrictive. It will be obvious to those skilled in the art to make various changes, alterations and modifications to the invention described herein. For example, while particular lists have been discussed in the body of this disclosure, other lists may be included or the databases may comprise entirely different lists than those set forth in the specification. The lists are to be considered illustrative and not restrictive. To the extent that these variations, modifications and alterations depart from the scope and spirit of the appended claims, they are intended to be encompassed therein.

We claim:

1. A method for providing caller ID information for outgoing telephone calls from a number of companies comprising the steps of:
reviewing each outgoing call at a primary switch cluster of a carrier to determine if the telephone call requires caller ID information;
if the call requires caller ID information, determining if the outgoing telephone call is carrying the originating call's caller ID information or if the outgoing telephone call is carrying a valid caller ID information packet;
if the call is not carrying any caller ID information or is carrying an invalid caller ID information packet, providing a predetermined caller ID information packet to said primary switch cluster to be matched with the call;
if caller ID information is not required, allowing the call to continue at said primary switch cluster.

2. The method according to claim 1 wherein a control computer analyzes the call to determine whether said call requires caller ID information to be carried with said call.

3. The method according to claim 1 wherein a database contains caller ID information to be inserted at the primary switch with calls requiring caller ID information.

4. The method according to claim 1 wherein said call is analyzed to determine if said call should be completed or blocked based on a comparison of said call's originating information and its destination information against a “do-not-call” block lists.

5. The method according to claim 2 wherein said control computer is physically in a location different than said primary switch.

6. The method according to claim 2 having two or more control computers.

7. The method according to claim 3 wherein a user inputs caller ID information into said database.

8. A method for providing caller ID information for outgoing telephone calls from a number of companies comprising the steps of:
reviewing each outgoing call at a primary switch cluster of a carrier to determine if the telephone call requires caller ID information;
if the call requires caller ID information, determining if the outgoing telephone call is carrying a desired caller ID information packet;
if the call is not carrying a desired caller ID information packet, providing a predetermined caller ID information packet to said primary switch cluster to be substituted in place of the original caller ID information packet;
if caller ID information is not required, allowing the call to continue at said primary switch cluster.

9. The method according to claim 8 wherein a control computer analyzes the call to determine whether said call requires caller ID information to be carried with said call.

10. The method according to claim 8 wherein a database contains caller ID information to be substituted at the primary switch with calls requiring caller ID information.

11. The method according to claim 8 wherein said call is analyzed to determine if said call should be completed or blocked based on a comparison of said call's originating information and its destination information against a “do-not-call” block lists.

12. The method according to claim 9 wherein said control computer is physically in a location different than said primary switch.

13. The method according to claim 9 having two or more control computers.

14. The method according to claim 10 wherein a user inputs caller ID information into said database.
